(19) United States
(12) Patent Application Publication
(10) Pub. No.: US 2010/0197513 A1
(43) Pub. Date: Aug. 5, 2010

(54) SYSTEMS AND METHODS FOR ASSOCIATING NUCLEIC ACID PROFILES AND PROTEOMIC PROFILES WITH HEALTHCARE PROTOCOLS AND GUIDELINES IN A DECISION SUPPORT SYSTEM

(75) Inventor: Yasser Alsafadi, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/377,240

(22) PCT Filed: Aug. 2, 2007
(86) PCT No.: PCT/IB07/53049

§ 371 Date: Feb. 11, 2009

Related U.S. Application Data
(60) Provisional application No. 60/822,091, filed on Aug. 11, 2006.

(51) Int. Cl. C40B 30/02; C40B 40/06

(52) U.S. Cl. 506/8; 506/16

(57) ABSTRACT

A system, a method and a computer-readable medium are provided for associating a nucleic acid profile or proteomic profile with a patient state, to utilize a healthcare protocol or guideline for decision support, in which the patient state provides a description of a current status and a history of a patient, and the nucleic acid profile or proteomic profile is an analysis of characteristics including genetic constitution, gene expression, or modification of the protein content of the tissue or cell, all of which aid in diagnosis of the disease state of a patient. The nucleic acid profile or proteomic profile shows a molecular indicator of the patient state. The invention also provides a method for associating a stage in the healthcare protocol or guideline with the nucleic acid profile or proteomic profile.

The technical field of the invention is providing a system, method and computer-readable medium for associating a nucleic acid profile or proteomic profile with a patient state to utilize a healthcare protocol or guideline for decision support.

Healthcare protocols and guidelines are systematically developed statements to assist a practitioner and/or patient to make decisions about appropriate healthcare for specific clinical conditions. Healthcare protocols and guidelines provide data regarding topics relating to medical modes, including prevention, diagnosis, prognosis and treatment. These healthcare protocols and guidelines can identify decision options and aid in healthcare decisions. (United States Department of Health and Human Services Agency for Healthcare Research and Quality, http://www.ahrq.gov) Studies have shown that computer-based implementation of healthcare protocols and guidelines, when integrated with healthcare workflow to provide patient specific recommendations at points of care, can improve clinician performance and patient outcomes. (J M Grimshaw et al., Lancet, 342(8883):1317-22, 1993; M E Johnston et al., Ann. Intern. Med., 120(2):135-42, 1994)

The European Federation of Neurological Societies task force on molecular diagnosis of neurologic disorders issues guidelines for the molecular diagnosis of inherited neurologic diseases. These guidelines contain a summary of the possibilities and limitations of molecular genetic diagnosis of some important inherited neurological diseases. Practical issues, such as diagnostic criteria that help to decide whether a molecular diagnostic test should be ordered, are emphasized. Some of the diseases addressed by these guidelines are non-degenerative movement disorders, inherited ataxias, neurodegenerative disorders, dementias, myopathies and muscular atrophies. (European Journal of Neurology, 8: 299-314, 2001)

Improvement of the quality of diagnostic assays is supported by the European Academy of Andrology and the European Molecular Genetics Quality Network through publication of the guideline for molecular diagnosis of Y-chromosomal microdeletions as exemplary genetic disorders. (M. Simoni et al., International Journal of Andrology, 27:240-249, 2004) Microdeletions of the Y chromosome and Klinefelter syndrome are the most frequent genetic causes of spermatogenetic failure in infertile men. The molecular diagnosis of Y-chromosomal microdeletions is routinely performed in the workup of male infertility in men with azoospermia or severe oligozoospermia. Both microdeletions of the Y-chromosome and Klinefelter syndrome are readily detected using a nucleic acid profile and/or proteomic profile.

However, for molecular guidelines there currently are no systematic tools and methods for associating different “primitives” or stages in a healthcare protocol or guideline, and a molecular indicator about the state of a disease. More specifically, current representations of healthcare protocols and guidelines do not support the ability to determine the expected or current state of a nucleic acid array or proteomic array of patients at particular points in a healthcare protocol or guideline.

Accordingly, an embodiment of the invention herein provides a system with a guideline representation for utilizing a healthcare protocol or guideline for decision support. A nucleic acid profile or proteomic profile is associated with a patient state. The patient state provides a description of a current status and history of a patient, and the nucleic acid profile or proteomic profile is an analysis of genetic constitution, gene expression, protein modification, or disease state. The system also associates a stage in the healthcare protocol or guideline with the nucleic acid profile or proteomic profile. The healthcare protocol or guideline has a purpose including but not limited to: screening and prevention; diagnosis and pre-diagnosis management of the patient; indications for use of at least one healthcare procedure; use of specific technologies and tests as part of healthcare care; care of healthcare conditions; eligibility to enroll in a healthcare trial; and eligibility to access healthcare services. The nucleic acid profile or proteomic profile provides a molecular indicator of the patient state.

A related embodiment provides a guideline representation that is comprised of action steps, decisions, and patient states. The actions steps include data collection and intervention.

In a related embodiment, metadata in the nucleic acid profile or proteomic profile is associated with an action step that is healthcare oriented and/or programming oriented. Metadata associated with a healthcare oriented action step recommends a molecular test to be performed on the patient. Metadata associated with a programming oriented action step instructs the system to search the patient record to retrieve the nucleic acid profile or proteomic profile.

An alternative embodiment provides a guideline representation that is a Guideline Element Model comprising an XML-based guideline document model that stores and organizes heterogeneous information contained in the healthcare protocol or guideline.

A related embodiment provides a comparison of a current profile for a patient with an expected profile obtained from the healthcare protocol or guideline. This comparison provides further decision support, including but not limited to: requesting molecular tests, indicating an observed deviation from an expected treatment response; locating at least one entry point in the healthcare protocol or guideline; proposing correct orders; presenting relevant patient data; presenting relevant reference information; alerting a clinician of a change in the patient state; and providing a suggestion for diagnosis or treatment of the patient.

An alternative embodiment provides performing a nucleic acid profile or proteomic profile test, and means for comparing a previous profile for the patient and the current profile. This comparison further provides decision support.

A related embodiment provides a comparison between the current profile with the entry point of the healthcare protocol or guideline to indicate eligibility to enroll in the healthcare protocol or guideline. The entry point identifies where the nucleic acid profile or proteomic profile is needed in the healthcare protocol or guideline.

A related embodiment provides retrieving a test result or observation from the current profile of the patient, and means for generating a reminder to perform a molecular test if the current profile for the patient is deficient or is not present.

In an alternative embodiment, the nucleic acid profile or proteomic profile is associated with a case step. The case step describes a profile of a decision option, and the profile of a patient is compared with a case profile. A guideline path associated with a corresponding profile of a decision option is followed.

An alternative embodiment provides a method of preparing a guideline recommendation for providing decision support. The method obtains and analyzes the following: data on a patient state, where the patient state provides a description of the current status and history of a patient; data on the medical history of family or associates of the patient; and a nucleic acid profile or proteomic profile of the patient. The method also associates the following: the nucleic acid profile or proteomic profile with the patient state, and a stage in a healthcare protocol or guideline with the nucleic acid profile or proteomic profile. The nucleic acid profile or proteomic profile provides a molecular indicator of the patient state.

An alternative embodiment provides a computer-readable medium which includes a guideline representation for utilizing a healthcare protocol or guideline for decision support; a nucleic acid profile or proteomic profile associated with a patient state; and associating a stage in the healthcare protocol or guideline with the nucleic acid profile or proteomic profile. The patient state shows a description of the current status of a patient, and the nucleic acid profile or proteomic profile is an analysis of genetic constitution, gene expression, protein modification, or disease state. The nucleic acid profile or proteomic profile shows a molecular indicator of the patient state.

It is an object of the present invention to associate primitives or stages of a healthcare protocol or guideline with nucleic acid profiles or proteomic profiles. A decision support system including these guidelines or healthcare protocols uses this information to perform at least one operation such as requesting molecular tests, indicating a deviation from expected response to treatment, locating entry points in a healthcare protocol or guideline, proposing correct orders, presenting relevant reference information, alerting a clinician of a change in the patient state, and providing a suggestion for diagnosis or treatment of the patient.

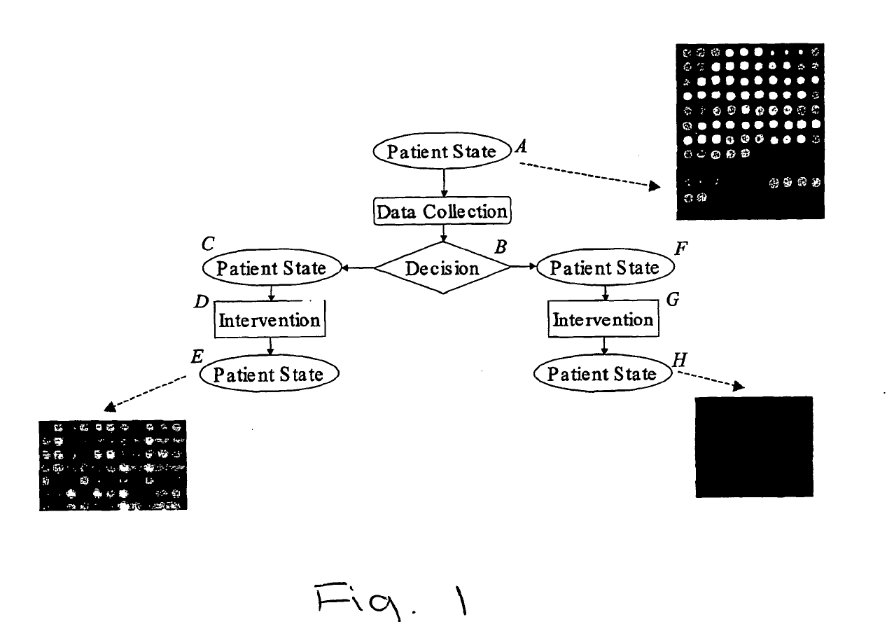

FIG. 1 is a diagram with photographs of micro-arrays that shows an example of a healthcare protocol or guideline with associations to nucleic acid profiles or proteomic profiles.

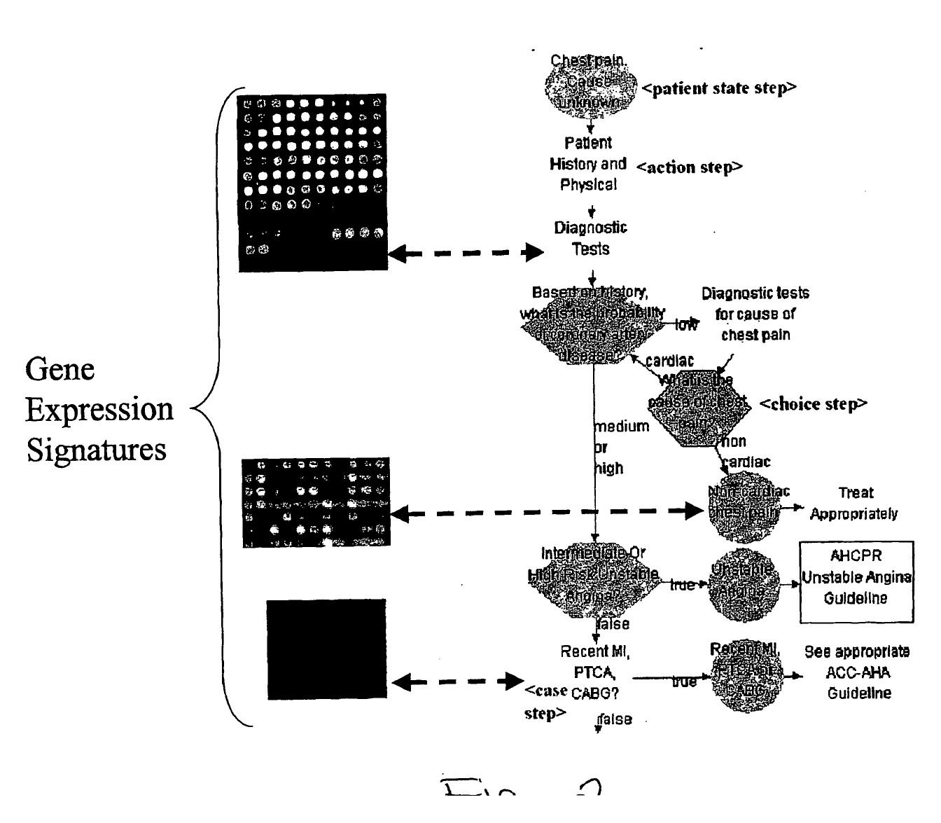

FIG. 2 is a diagram with photographs of micro-arrays that shows a decision support system that includes analyzing a patient state, collecting data on the patient, providing decision support, analyzing the patient state, suggesting an intervention, and further analyzing the patient state.

Analysis of genetic constitution and gene expression is central to molecular diagnostics. A genomic or nucleic acid micro-array having DNA spots, or a proteomic micro-array having protein spots, is a tool that enables a cell- and even organism-wide view of genetic constitution and/or gene expression, and is useful for obtaining comprehensive pictures of cell function. Micro-arrays are particularly powerful tools because of their unsurpassed sensitivity, specificity, and reproducibility. A re-classification of diseases based on nucleic acid profiles or proteomic profiles can be developed based on data obtained from micro-arrays.

Each micro-array is made up of many copies of bits of single-stranded DNA fragments arranged in a grid pattern on a glass or plastic surface. When DNA or RNA samples are applied to a micro-array, sequences in a sample that find a match will bind to a specific spot on the micro-array. If a DNA or RNA sequence is present both on the array and on one or both samples, the sequences, some of which are fluorescently tagged, bind, and a fluorescent signal can be detected at a specific spot on the array. The signals are picked up using a “reader” or “scanner” that includes lasers, a special microscope, and a camera, which work together to create a digital image of the array. Special computer programs then calculate a percentage binding, for example, each of a red to green fluorescent dye, and the ratio of those dyes in each spot. The calculated ratio for each spot on the array reflects the relative expression or presence of a given gene, or genetic marker, or nucleic acid sequence, in the two samples. For example, a red signal indicates that a particular gene is present or expressed in sample A but not sample B; a green signal that the gene is present or expressed in sample B but not sample A; and a yellow signal that the gene is present or expressed at roughly equal levels in both samples. Absence of a signal indicates that the gene is, for example, not present or is not expressed in either sample. The data obtained from a nucleic acid or proteomic analysis or assay is referred to as a nucleic acid or proteomic “profile”, which is a molecular signature. A distinction between nucleic acid profiles for analyzing genetic constitution and gene expression can be made by use either of a sample of a patient's DNA, or by use of a patient's RNA, converted to cDNA by reverse transcription. Further, unusual high levels of presence or expression can also be detected by micro-arrays, and correlated with known conditions.

With reference to FIG. 1, a nucleic acid profile or proteomic profile of a patient can be used to provide decision support for a patient with a medical problem, such as a chest pain. A patient state, including current status and history of a patient, is analyzed. An action step of data collection and/or intervention occurs after the patient state is analyzed. This can include, for example, acquiring a patient history and/or performing a physical. Diagnostic tests can then be performed. The system aids in determining, based on patient history, what the probability is of a certain diagnosis for the patient. For example, if the patient history showed that the probability of coronary artery disease for the patient is low, then diagnostic tests for the cause of chest pain can be performed.

If the cause of the chest pain is determined to be, for example, non-cardiac, then the system suggests how to treat the chest pain appropriately.

If the cause of chest pain is determined to be, for example, cardiac, or if the probability of coronary artery disease is medium or high, then the system provides additional decision support. For example, if the patient has intermediate or high risk unstable angina, then the Agency for Health Care Policy and Research (AHCPR) guideline for Unstable Angina can be associated with the patient profile and used to aid in treatment.

If the patient does not have intermediate or high risk unstable angina, and has recently had, for example, a myocardial infarction (MI), percutaneous transluminal coronary angioplasty (PTCA), or coronary artery bypass graft (CABG), then the appropriate guidelines, for example those of the American College of Cardiology (ACC) or the American Heart Association (AHA), can be used to aid in treatment of the patient.

A decision support system has a series of several alternative steps, as shown in FIG. 2. At an early stage, a patient state is analyzed based on a nucleic acid profile or proteomic profile of the patient. The patient state describes the current status and history of the patient obtained from analysis of the nucleic acid profile or proteomic profile, and/or other sources of information. Data is collected on the patient, which may include information gathered from sources such as a patient history, molecular tests, or a physical exam. The system provides support for making a decision regarding patient care. After a decision is made, for example with regard to the patient's course of treatment, the patient state is reexamined. Once the patient state is reexamined, an intervention in the patient's care may take place. Following an intervention in patient care, the patient state is further analyzed.

The development of computer understandable formats for representing healthcare protocols and guidelines has been a major thrust of medical artificial intelligence (AI) research. Early approaches to computer-interpretable guidelines were limited to simple rule-based systems that triggered a single action, such as Arden Syntax (Arden Syntax for Medical Logic Systems, Columbia University http://www.cpmc.columbia.edu/arden/) or simple decision tables, such as the Guideline Element Model (GEM) system. (Shiffman, R. N., et al., J Am Med Inform Assoc., 7(5):488-498, 2000) More recently, this work was extended to multi-step guideline modeling methods based on a formal representation, focusing on issues as temporal reasoning and planning, the handling of uncertainty, and ontologies. A number of multi-step guideline representation formats (modeled as a hierarchical set of nested guideline tasks) have been developed, including GLIF, EON, Asbru, Prodigy, Prestige, and ProForma (Peleg, M., et al., Stanford University, Report No.: SMI-2002-0923, 2002)

The decision support system includes a guideline representation for utilizing a healthcare protocol or guideline for decision support. Molecular guidelines can be represented in an executable representation in order to utilize them in decision support systems. The guideline representation can be an executable guideline format, such as

Guideline Interchange Format (GLIF). An executable guideline representation, such as GLIF, includes the following: action steps, e.g., data collection and intervention; decisions; and patient states. (D. W. Wang, User Manual of the GLIF3 Guideline Execution Engine (GLEE), Columbia University, 2003) The GuideLine Interchange Format (GLIF) specification consists of the GLIF model and the GLIF syntax. The GLIF model is an object-oriented representation that consists of a set of classes for guideline entities, attributes for those classes, and data types for the attribute values. The GLIF syntax specifies the format of the test file that contains the encoding. (L. Ohno-Machado, et al., The GuideLine Interchange Format: a model for representing guidelines. JAMIA, 5(4): p. 357-372, 1998) In a GLIF representation, a stage in the healthcare protocol or guideline includes a reference to a representation of a nucleic acid profile or proteomic profile, which can include a graphic, an image, or a list. The modelers of a guideline specify criteria on what constitutes a correspondence among profiles to varying degrees of precision based on the healthcare knowledge.

The guideline representation can also be a non-executable format, such as read-only documents or the Guideline Element Model (GEM). Many guideline representations are disseminated as read-only documents, usually in narrative form, e.g., on paper, in a PDF file, or in an HTML file. The GEM is an XML-based guideline document model that can store and organize the heterogeneous information contained in healthcare protocols and guidelines. It is intended to facilitate translation of natural language guideline documents into a format that can be processed by computers. The GEM is constructed as a hierarchy of more than 100 discrete tags with 9 major branches: Identity, Developer, Purpose, Intended Audience, Target Population, Method of Development, Testing, Review Plan, and Knowledge Components.

Five types of guidelines or healthcare protocols, categorized by purpose, are included in a report by the Institute of Medicine. These purposes include but are not limited to: screening and prevention, e.g. for vaccination for pregnant women who are planning international travel; diagnosis and pre-diagnosis management of patients, e.g., valuation of chest pain in the emergency room; indications for use of surgical procedures, e.g., indications for carotid endarterectomy; appropriate use of specific technologies and tests as part of healthcare, e.g., use of autologous or donor blood for transfusions; and guidelines for care of healthcare conditions, e.g., management of patients following coronary-artery bypass graft. (Institute of Medicine, http://www.iom.edu; L. Ohno-Machado, et al., The GuideLine Interchange Format: a model for representing guidelines. JAMIA, 5(4): p. 357-372, 1998)

A profile such as a nucleic acid profile or proteomic profile, is associated with a patient state describing the current status and history of a patient. Nucleic acid profiles using cDNA, and proteomic profiles, analyze genetic constitution or gene expression, i.e., gene products that are RNA and protein, respectively. Other examples of a profile suitable for the invention herein can also be used to obtain a profile of gene products, e.g., data obtained from mass spectrometry tests could be used to determine the protein composition of a sample taken from the patient. Deletions or amplifications in a gene could also be included as part of the profile in combination with mass spectrometry. The nucleic acid profile or proteomic profile is an analysis of characteristics including but not limited to genetic constitution, gene expression, and protein modification, all of which aid in diagnosis of the disease state of a patient. “Protein modification” as used herein means a change in the protein content of the cell or tissue sample as indicated by a proteomic profile, mass spectrometry, or any other analytical technique. In general, a protein modification is due to a change in gene expression, however in comparison to a normal subject, may be due to a change in genetic constitution. However, it is envisioned that a change in a proteomic profile may be due to and can include post-translational changes to one or more proteins, such as glycosylation, acetylation, formylation, adenylylation, or other changes commonly referred to as protein modification. The decision support system associates a stage in the healthcare protocol or guideline with the nucleic acid profile or proteomic profile, which allows the nucleic acid profile or proteomic profile to provide a molecular indicator of the patient state.

A profile for a patient that is recently obtained, i.e. a current profile, is compared with an expected profile stored in and obtained from the healthcare protocol or guideline. A discrepancy between the current profile and the expected profile generates an alert to the clinician and/or user, for example, that the patient's response to treatment is deviating from the expected. The comparison between the current profile and the expected profile also helps to provide further decision support, including but not limited to requesting molecular tests, indicating an observed deviation from an expected treatment response, locating an entry point in the healthcare protocol or guideline, proposing correct orders, presenting relevant reference information, alerting a clinician of a change in the patient state, and providing a suggestion for diagnosis or treatment of the patient. Furthermore, the system aids in retrospective reporting by enabling precise clinician practice audit and feedback.

Additionally, a nucleic acid profile or proteomic profile associated with a patient state serves as an entry point into a healthcare protocol or guideline. When a patient arrives at a clinic, a nucleic acid or proteomic test is performed and the patient's current state is compared to the last patient state that was recorded for that patient. If the patient is not at the same state, the decision support system finds a corresponding nucleic acid profile or proteomic profile in the healthcare protocol or guideline and suggests enrollment at a particular point. Comparing the current profile with the entry point of the healthcare protocol or guideline can also indicate eligibility to enroll in the healthcare protocol or guideline. The entry point can identify where the nucleic acid profile or proteomic profile is needed in the healthcare protocol or guideline. Test results and observations can be retrieved from the current profile of the patient. If the current profile for the patient is deficient or is not present in the patient's record, i.e. has not yet been obtained, an alert or a reminder to perform the necessary molecular tests is generated.

If the nucleic acid profile or proteomic profile for the patient has changed, a corresponding nucleic acid profile or proteomic profile in the healthcare protocol or guideline is located, and an entry point in the healthcare protocol or guideline is suggested. A nucleic acid profile or proteomic profile associated with the first step of a healthcare protocol or guideline or entry point of a healthcare protocol or guideline can indicate eligibility to enroll in this guideline. One can imagine a system that searches current patient's profile against a repository of healthcare protocols or guidelines to find which healthcare protocol or guideline is suitable for this particular patient or group of patients. This procedure is a type of personalized medicine where treatment is selected based on a patient's nucleic acid profile or proteomic profile.

The nucleic acid profile or proteomic profile can also contain metadata. Metadata associated with a nucleic acid profile or proteomic profile, such as the type of test, is associated with an action step, such as data collection or intervention, that is healthcare oriented and/or programming oriented. Metadata associated with a healthcare oriented action step recommends the molecular test to be performed on the patient. Metadata associated with a programming oriented action step instructs the system to search the patient record to retrieve the nucleic acid profile or proteomic profile.

The nucleic acid profile or proteomic profile can also be associated with a case step. When the nucleic acid profile or proteomic profile is associated with a case step, profiles of different decision options are described. When the healthcare protocol or guideline is executed, the decision support system compares the nucleic acid profile or proteomic profile of a patient with a canonical profile associated with a case step. The decision support system follows the guideline or healthcare profile path associated with the corresponding profile of a decision option. Healthcare protocol or guideline designers can prepare a default alternative in case a corresponding profile was not found.

A guideline recommendation is generated for providing decision support by obtaining and analyzing various data. Types of data that may be included are: data on a patient state, where the patient state provides a description of the current status of a patient; data on the medical history of the patient; and a nucleic acid profile or proteomic profile of a patient. The nucleic acid profile or proteomic profile can be associated with the patient state. The stage in a healthcare protocol or guideline can also be associated with the nucleic acid profile or proteomic profile. The nucleic acid profile or proteomic profile provides a molecular indicator of the patient state.

It will furthermore be apparent that other and further forms of the invention, and embodiments other than the specific and exemplary embodiments described above, may be devised without departing from the spirit and scope of the appended claims and their equivalents, and therefore it is intended that the scope of this invention encompasses these equivalents and that the description and claims are intended to be exemplary and should not be construed as further limiting.

What is claimed is:

1. A system comprising:
a guideline representation for utilizing a healthcare protocol or guideline for decision support;
a nucleic acid profile or proteomic profile associated with a patient state and a stage in the healthcare protocol or guideline, wherein the patient state provides a description of a current status and history of a patient, and wherein the nucleic acid profile or proteomic profile comprises at least one of genetic constitution, gene expression, protein modification, or disease state, and provides a molecular indicator of the patient state.

2. The system according to claim 1, wherein the healthcare protocol or guideline has a purpose selected from the group comprising: screening and prevention; diagnosis and pre-diagnosis management of the patient; indications for use of at least one healthcare procedure; use of specific technologies and tests as part of healthcare care; care of healthcare conditions; eligibility to enroll in a healthcare trial; and eligibility to access healthcare services.

3. The system according to claim 1, wherein the guideline representation comprises at least one of action steps, decisions, and patient states, wherein the action steps comprise at least one of data collection and intervention.

4. The system according to claim 1, wherein the guideline representation is a Guideline Element Model comprising an XML-based guideline document model that stores and organizes heterogeneous information contained in the healthcare protocol or guideline.

5. The system according to claim 1, further comprising means for comparing a current profile for a patient with an expected profile obtained from the healthcare protocol or guideline.

6. The system according to claim 5, wherein the means for comparing provides further decision support comprising at least one of: requesting at least one molecular test, indicating an observed deviation from an expected treatment response; locating at least one entry point in the healthcare protocol or guideline; proposing correct orders; presenting relevant patient data; presenting relevant reference information; alerting a clinician of a change in the patient state; and providing a suggestion for diagnosis or treatment of the patient.

7. The system according to claim 6, wherein the means for comparing the current profile with the entry point of the healthcare protocol or guideline indicates eligibility to enroll in the healthcare protocol or guideline.

8. The system according to claim 6, wherein the entry point identifies where the nucleic acid profile or proteomic profile is needed in the healthcare protocol or guideline.

9. The system according to claim 1, further comprising means for retrieving at least one test result or observation from the current profile of the patient, and means for generating a reminder to perform at least one molecular test if the current profile for the patient is deficient or is not present.

10. The system according to claim 1, further comprising means for performing a nucleic acid profile or proteomic profile test, and means for comparing a previous profile for the patient and the current profile.

11. The system according to claim 10, wherein the means for comparing provides decision support comprising at least one of: requesting molecular tests; indicating a deviation from an expected treatment response; locating entry points in a guideline; proposing correct orders; presenting relevant patient data; presenting relevant reference information; alerting a clinician of a change in the patient state; and providing a suggestion for diagnosis or treatment of the patient.

12. The system according to claim 1, wherein the system uses the nucleic acid profile or proteomic profile to perform at least one of: requesting molecular tests; indicating a deviation from an expected treatment response; locating entry points in a guideline; proposing correct orders; presenting relevant patient data; presenting relevant reference information; presenting relevant reference information; alerting a clinician of a change in the patient state; and providing a suggestion for diagnosis or treatment of the patient.

13. The system according to claim 1, further comprising metadata in the nucleic acid profile or proteomic profile, wherein the metadata is associated with an action step that is healthcare oriented and/or programming oriented, wherein the metadata associated with the healthcare oriented action step further comprises recommending the molecular test to be performed on the patient; and wherein the metadata associated with the programming oriented action step further comprises instructing the system to search the patient record to retrieve the nucleic acid profile or proteomic profile.

14. The system according to claim 1, wherein the nucleic acid profile or proteomic profile is associated with a case step, wherein the case step describes a profile of at least one decision option, and wherein the system compares the profile of a patient with at least one case profile, wherein the system follows a guideline path associated with a corresponding profile of the at least one decision option.

15. A method of preparing a guideline recommendation for providing decision support, comprising:
obtaining and analyzing at least one of the following: data on a patient state, wherein the patient state provides a description of the current status and history of a patient; data on the medical history of family or associates of the patient; and a nucleic acid profile or proteomic profile of the patient;
associating at least one of: the nucleic acid profile or proteomic profile with the patient state, and a stage in a healthcare protocol or guideline with the nucleic acid profile or proteomic profile, wherein the nucleic acid profile or proteomic profile provides a molecular indicator of the patient state; and
providing decision support consisting of at least one of: requesting molecular tests;
indicating a deviation from an expected treatment response; locating entry points in a guideline; proposing correct orders; presenting relevant patient data; presenting relevant reference information; presenting relevant reference information; alerting a clinician of a change in the patient state; providing a suggestion for diagnosis or treatment of the patient; eligibility to enroll in a healthcare trial; and eligibility to access healthcare services.

16. The method according to claim 15, which further comprises steps of:
comparing a current profile for a patient with an expected profile obtained from the healthcare protocol or guideline; and
using the nucleic acid profile or proteomic profile to perform at least one of: requesting molecular tests; indicating a deviation from an expected treatment response; locating entry points in a guideline; proposing correct orders; presenting relevant patient data; presenting relevant reference information; presenting relevant reference information; alerting a clinician of a change in the patient state; providing a suggestion for diagnosis or treatment of the patient; eligibility to enroll in a healthcare trial; and eligibility to access healthcare services.

17. The method according to claim 15, which, further comprises at least one of the steps of:
comparing a previous profile for the patient and the current profile;
locating a corresponding nucleic acid profile or proteomic profile in the healthcare protocol or guideline; and
suggesting the entry point in the healthcare protocol or guideline if the nucleic acid profile or proteomic profile for the patient has changed.

18. A computer-readable medium comprising:
a guideline representation for utilizing a healthcare protocol or guideline for decision support;
a nucleic acid profile or proteomic profile associated with a patient state, wherein the patient state provides a description of the current status of a patient, and wherein the nucleic acid profile or proteomic profile is an analysis of at least one of genetic constitution, gene expression, protein modification, or disease state; and
means for associating a stage in the healthcare protocol or guideline with the nucleic acid profile or proteomic profile, wherein the nucleic acid profile or proteomic profile provides a molecular indicator of the patient state.

19. A computer-readable medium which, when executed, implements the method of claim 15.
